(19) United States
(12) Patent Application Publication
(10) Pub. No.: US 2004/0231864 A1
(43) Pub. Date: Nov. 25, 2004

(54) Digging apparatus and methods of using same

(76) Inventor: Warren Newman, Inez, TX (US)

Correspondence Address: WILLIAMS, MORGAN & AMERSON, P.C., 10333 RICHMOND, SUITE 1100, HOUSTON, TX, 77042, US

(21) Appl. No.: 10/440,663

(22) Filed: May 19, 2003

(51) Int. Cl. A01B 13/00

(52) U.S. Cl. 172/25

(57) ABSTRACT

The present invention is generally directed to a digging apparatus and methods of using same. In one illustrative embodiment, the apparatus comprises a body having a top surface and a bottom surface, a plurality of openings formed in the body and a blade positioned in each of the openings and coupled to the body, wherein a portion of the blade extends beyond the bottom surface of the body. In some cases, the blades are comprised of a material having a hardness less than approximately 90 Brinell, i.e., less than the hardness of underground piping. The present invention is also directed to a method that comprises providing a body having a top surface, a bottom surface and a plurality of openings formed in the body, positioning a blade in each of the openings and coupling the blade to the body, wherein a portion of the blade extends beyond the bottom surface of the body, positioning the blades in contact with an earthen surface, and rotating the body to advance the body into the earthen material.

### BACKGROUND OF THE INVENTION

1. Field of the Invention

The present invention generally relates to earth moving tools and devices, and, more particularly, to an earth shaving apparatus and methods of using same.

2. Description of the Related Art

Industrial construction activities often involve digging holes into the earth for a variety of purposes. For example, such holes may be dug for purposes of installing various structures, such as utility poles. Typically, the earthen material is removed through use of a screw-like auger that is rotated into the earth by a suitable driving device. Typically, these screw-like auger tools are made of metal.

Unfortunately, in many cases, the digging must be performed in areas where underground utilities, e.g., gas, electric, etc., are located nearby. Typically, the utilities, e.g., gas, flow through metallic pipes that are wrapped with, for example, insulation or rust-proofing materials, and buried underground. Great effort is taken to insure that such underground utilities are properly located in advance of beginning digging operations. Such efforts include, but are not limited to, the use of metallic sensors to detect the location of buried underground piping. Despite these efforts, it is still very difficult to precisely locate all of the underground utilities. This is even more problematic in older industrial plants where there is little, if any, existing documentation, i.e., drawings, as to even the general location of such underground facilities.

Digging in areas where such underground utilities are located can be very hazardous. For example, inadvertently hitting an underground gas line or chemical line may lead to a fire, an explosion, a release of undesirable chemicals into the environment or injuries to the persons conducting such digging operations. The metallic augers typically used for digging in such areas can quickly damage or rupture such underground piping. That is, despite efforts to the contrary, such metallic augers may damage the underground utilities without the digging operator recognizing that damage is occurring. Currently, when digging operations are conducted in areas where underground utilities are believed to exist, the digging operations are conducted very carefully and very slowly in an effort to avoid damaging the underground utilities. As a result, such digging operations become more time-consuming and more expensive.

The present invention is directed to a device and method that may solve, or at least reduce, some or all of the aforementioned problems.

### SUMMARY OF THE INVENTION

The present invention is generally directed to various embodiments of a digging apparatus and to various methods of using such devices. In one illustrative embodiment, the apparatus comprises a body having a top surface and a bottom surface, a plurality of openings formed in the body and a blade positioned in each of the openings and coupled to the body, a portion of the blade extending beyond the bottom surface of the body.

In another illustrative embodiment, the apparatus comprises a body that has a bottom surface and a plurality of openings formed in the body, and a blade positioned in each of the openings, the blade being comprised of a material having a hardness less than approximately 90 Brinell. In further aspects, the blade may be removably coupled to the body and a portion of the blade may extend beyond the bottom surface of the body.

In a further illustrative embodiment, the apparatus comprises a body having a top surface and a bottom surface, a plurality of openings formed in the body, means for removing earthen material positioned in each of the openings and coupled to the body, wherein a portion of the means for removing earthen material extending beyond the bottom surface of the body, and means for rotating the body. In one specific embodiment, the means for removing the earthen material is a blade.

In yet another illustrative embodiment, a method of removing earthen material is disclosed which comprises providing a body having a top surface, a bottom surface and a plurality of openings formed in the body, positioning a blade in each of the openings and coupling the blade to the body such that a portion of the blade extends beyond the bottom surface of the body, positioning the blades in contact with an earthen surface, and rotating the body to advance the body into the earth. The method further comprises, after the body has been advanced by the rotation to thereby define a hole, removing the body from the hole and removing collected earthen material from above the top surface of the body. In some embodiments, the method further comprises repositioning the body in the hole after removing the collected earthen material and rotating the body to further increase a depth of the hole, wherein the body is rotated by applying a rotational force to a member that is coupled to a kelley box, the kelley box being fixedly coupled to the body.

### BRIEF DESCRIPTION OF THE DRAWINGS

The invention may be understood by reference to the following description taken in conjunction with the accompanying drawings, in which like reference numerals identify like elements, and in which:

FIG. 1 is an assembly drawing depicting a plan view of one illustrative embodiment of a digging tool of the present invention

FIGS. 2-3 are, respectively, plan and bottom views of one illustrative embodiment of portions of the present invention;

FIGS. 4A-4D are side views depicting various aspects of portions of the present invention;

FIGS. 5 and 6 are plan views of one illustrative embodiment of the blades that may be used with the present invention;

FIG. 7 is a cross-sectional side view depicting an embodiment of the invention wherein a protective layer may be employed; and

FIGS. 8A-8C are various views depicting one illustrative example of how the present invention may be used.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF THE INVENTION

Illustrative embodiments of the invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The present invention will now be described with reference to the attached drawings which are included to describe and explain illustrative examples of the present invention. The words and phrases used herein should be understood and interpreted to have a meaning consistent with the understanding of those words and phrases by those skilled in the relevant art. No special definition of a term or phrase, i.e., a definition that is different from the ordinary and customary meaning as understood by those skilled in the art, is intended to be implied by consistent usage of the term or phrase herein. To the extent that a term or phrase is intended to have a special meaning, i.e., a meaning other than that understood by skilled artisans, such a special definition will be expressly set forth in the specification in a definitional manner that directly and unequivocally provides the special definition for the term or phrase.

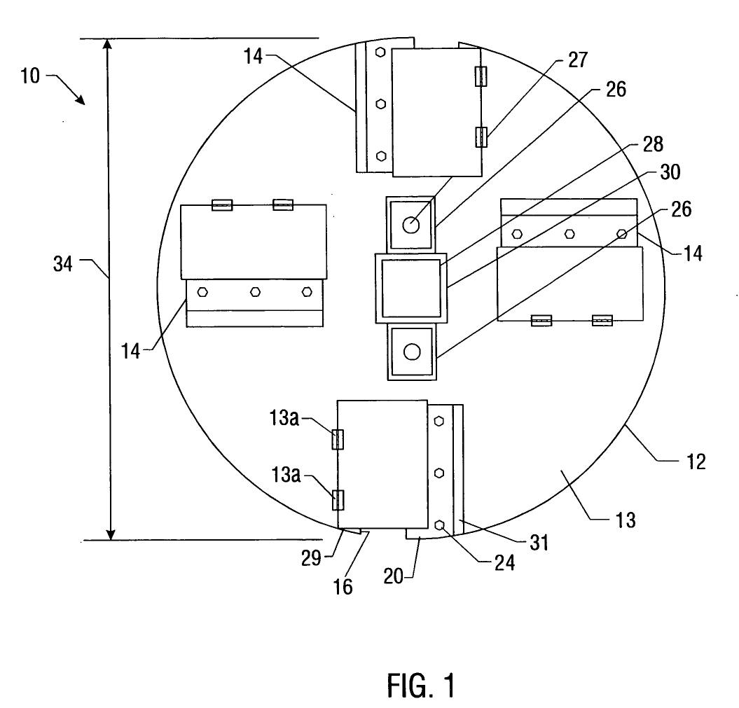

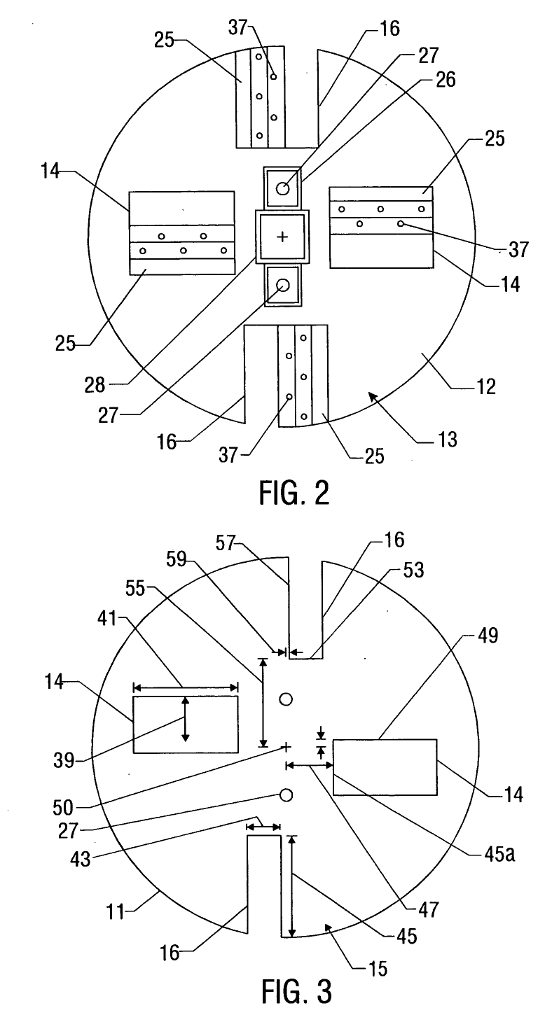

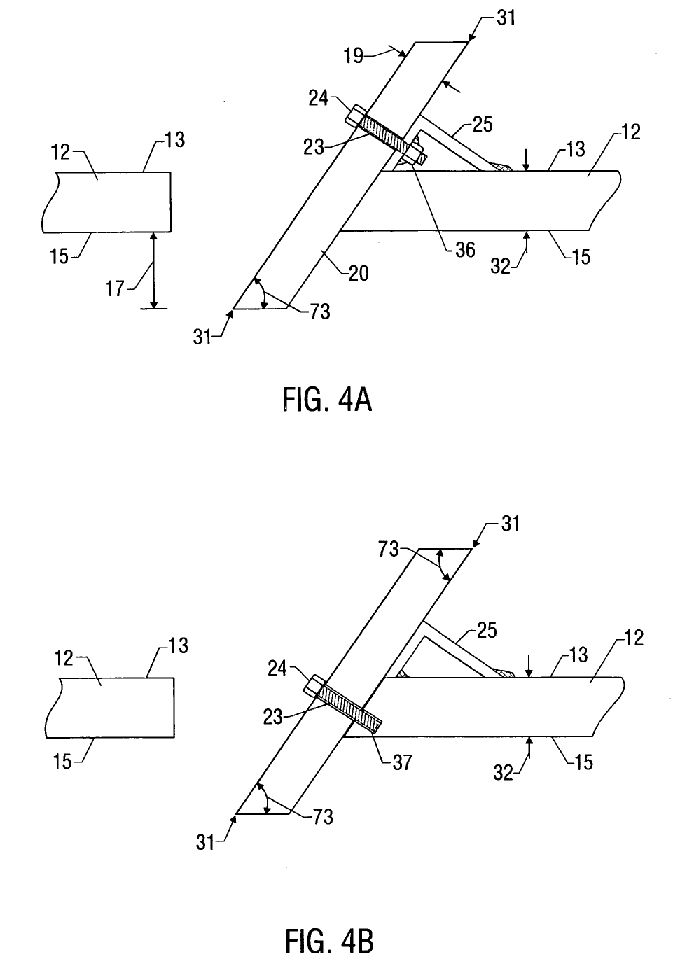

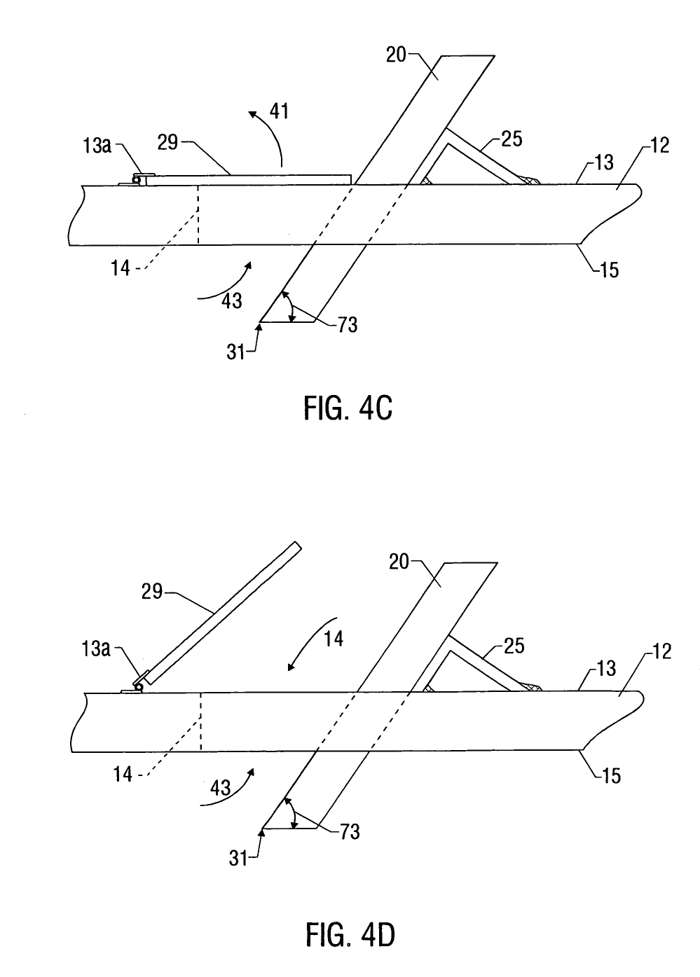

FIG. 1 is an assembly drawing depicting a plan view of one illustrative embodiment of a digging tool 10 of the present invention. FIGS. 2-3 depict, respectively, plan and bottom views of various portions of one illustrative embodiment of the digging tool 10. As shown in FIGS. 1-3, the tool 10 is comprised of a body 12, having a plurality of inside openings 14 and a plurality of outside openings 16. The body 12 has a top surface 13 and a bottom surface 15. A blade 20 is positioned within each of the outside openings 16 and each of the inside openings 14. As described more fully below, in one embodiment, the blades 20 may be removable, and they may have a different configuration depending upon the size, shape and positioning of the openings 14, 16. In one embodiment, the blades 20 are secured to the tool 10 by a plurality of fasteners, e.g., bolts 24, and a blade support member 25. The blades 20 are positioned such that a cutting edge 31 (see FIG. 4A) of the blade 20 extends beneath a bottom surface 15 of the body 12 by a distance 17. The tool 10 further comprises a plurality of vents 26 and a kelley box 28 having openings 30 formed therein. The vents 26 are in communication with the openings 27 formed through the body 12. A plurality of deflectable members 29 are hinged to the body 12, via hinges 13A, and positioned above portions of the openings 16 and 14 for purposes that will be described more fully below.

The various structural components described above may be made of a variety of different materials, and the size of such components may vary. For example, the body 12 may have a generally cylindrical or disk-like configuration having a circular cross-sectional configuration, and it may be manufactured from a carbon or stainless steel plate having a thickness 32 of, for example, approximately one inch. In other embodiments, the body 12 may be made of a material having a hardness less than approximately 90 Brinell, e.g., nylon, plastic, rubber, bakelite, etc. The body 12 may, in some embodiments, be made of a material like that described below for the blade 20.

In the depicted embodiment, the bottom surface 15 has a generally planar surface. However, it should be understood that the configuration of the bottom surface 15 may be varied without departing from the spirit and scope of the present invention. In some cases, a relatively short alignment/pilot guide or pin (not shown) may extend from approximately the center of the bottom surface 15 of the body 12 to aide in initially positioning and maintaining the body 12 in the desired location when digging operations are started. If employed, such a guide pin would be made of a material like that described below for the blade 20. The diameter 34 of the generally cylindrical body 12 may vary depending upon the particular application. In one illustrative embodiment, the diameter 34 of the tool 10 may be approximately 36-48 inches. The vent pipes 26 may be comprised of, for example, sections of 3″33 3″ square structural tubing that are welded to the body 12. The kelley box 28 may be manufactured from ½-1″ plate steel to any desired internal dimensions and it may be welded to the body 12. The kelley box 28 is sized and configured such that a drive member (not shown in FIGS. 1-3) from a digging machine, such as pressure-digger or boom-digger, may be coupled to the tool 10 by a pinned connection through the openings 30 in the kelley box 28. Ultimately, the digging machine will be used to supply a downforce and rotary motion to the tool 10 as it is advanced into the earth. The digging machine and the drive member comprise a means for rotating the tool 10.

In one embodiment of the present invention, the blades 20 may be removably coupled to the body 12. Such coupling may be accomplished by a variety of techniques. FIGS. 4A-4B depict one illustrative technique for removably coupling the blades 20 to the body 12. As shown therein, a blade support member 25 is used to couple the blade 20 to the body 12. The blade support member 25 may consist of a variety of different types of structural support members. As shown in FIGS. 4A-4B, the blade support member 25 is comprised of structural angle iron, e.g., 3″×3″½″, that is welded to the body 12. A plurality of nuts 36 are welded to the angle iron blade support members 25 as shown in the attached drawings. In the illustrative example depicted in the drawings, the blades 20 are removably coupled to the body 12 and the blade support members 25 by a plurality of bolts 24 that extend through holes 23 formed in the blades 20. In the depicted embodiment, the blades 20 are removably coupled to the body 12 by five bolts 24, three of which are threadingly mated to the nuts 36 attached to the blade support member 25. As shown in FIG. 4B, two of the bolts 24 that are used to secure the blades 20 to the body 12 are threadingly engaged with threaded holes 37 formed in the body 12. Of course, the manner in which the blades 20 are removably coupled to the body 12 may vary. For example, fewer or more than five bolts 24 may be used to couple the blades 20 to the body 12. As another example, the blade 20 may be secured to the body 12 or a support member attached thereto by a clevis pin type joint, a tongue and groove arrangement or a variety of other known mechanical attachment configurations. Thus, the particular manner depicted herein for coupling the blades 20 to the body 12 should not be considered a limitation of the present invention unless such limitations are clearly set forth in the appended claims.

The size and configuration of the openings 14, 16 and the blades 20 positioned therein may also vary. However, the inside openings 14 and outside openings 16 should be formed such that there is some degree of overlap between the openings 14, 16 when the tool 10 is rotated, as described more fully below. In one illustrative embodiment, when the diameter of the body 12 is approximately 48 inches, the inside openings 14 have a width 39 (see FIG. 3) of approximately 24 inches and a length 41 of approximately 24 inches. In this embodiment, the outside openings 16 have a width 43 of approximately 8 inches and a length 45 of approximately 24 inches. In the depicted embodiment, the outside openings 16 are not bounded by the edge 11 of the body 12. In one embodiment, the inside edge 45A of the inside openings 14 is laterally offset by a distance 47 of approximately 3 inches from the center 50 of the body 12, while the back edge 49 of the inside opening 14 is laterally offset by a distance 51 of approximately 21 inches from the center 50. The inside edge 53 of the outside opening 16 is laterally offset by a distance 55 of approximately 21 inches from the center 50 while the back edge 57 of the outside opening 16 is laterally offset by a distance 59 of approximately 3 inches from the center 50. In both cases, the inside openings 14 and outside openings 16 are considered to have a generally rectangular configuration, even though the outside openings 16 are not bounded on the perimeter of the body 12.

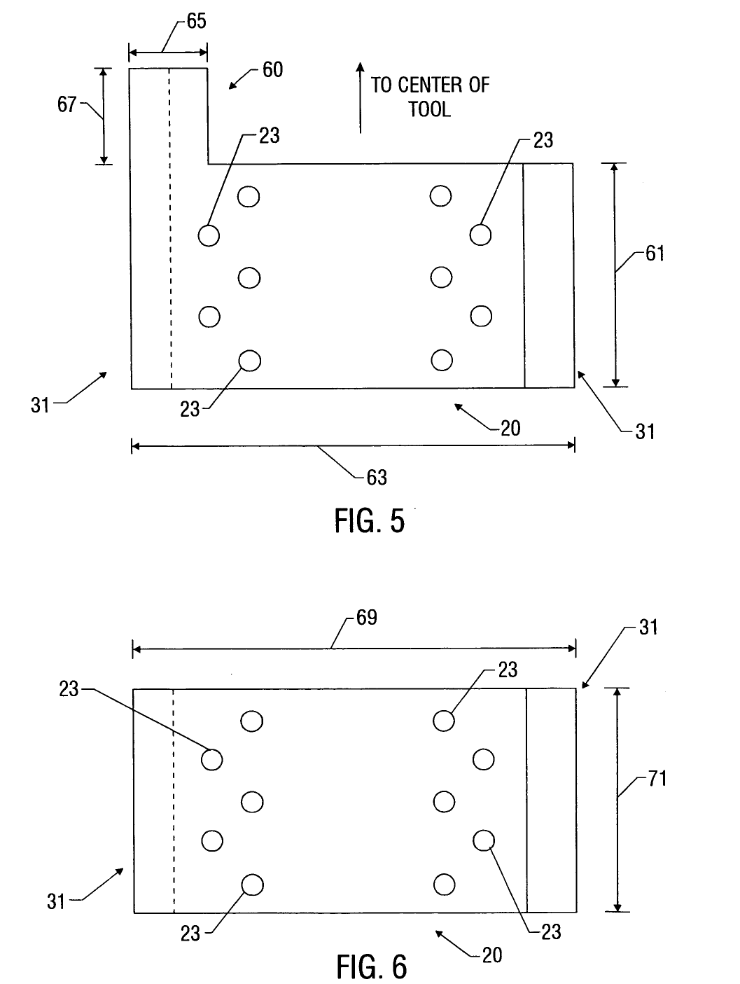

In general, in the embodiments where the blades 20 are removable, they are sized to fit in the various openings 14, 16 in the tool 10. FIGS. 5 and 6 are plan views of the blades 20 that may be positioned in the inside openings 14 and outside openings 16, respectively. In the disclosed embodiment of the present invention, the blades 20 positioned in the openings 14, 16 have different configurations. However, as will be understood by those skilled in the art after a complete reading of the present invention, the present invention may be employed in situations where the blades 20 are of the same or different configuration, and where fewer or greater numbers of blades 20 than those depicted in the drawings may be employed. The blade 20 depicted in FIG. 5 is sized and configured so as to fit within the inside openings 14. The blade 20 has an extension 60 that extends inwardly toward the kelley box 28. Although the extension 60 may not be required in all situations, the extension 60 is provided to remove the soil between the inside edges 45A (see FIG. 3) of the inside openings 14 in the body 12. In the depicted embodiment, the blade 20 depicted in FIG. 5 may have a width 61 of approximately 12 inches and a length 63 of approximately 24 inches. The extensions 60 may be approximately 1 inch in length 65 and 3 inches in width 67. The blade 20 shown in FIG. 6 is adapted to be positioned in the outside opening 16, and it has a length 69 of approximately 24 inches and a width 71 of approximately 12 inches.

The blades 20 have cutting edges 31 formed on each end of the blade 20. The cutting edges 31 may be formed at a variety of different angles 73 (see FIG. 4A) depending upon soil conditions, desired removal rates, etc. For example, the angle 73 of the cutting edge 31 may range from approximately 45-60 degrees. In one particularly illustrative embodiment, the angle 73 may be approximately 45 degrees. In one embodiment, multiple sets of holes 23 are provided on the blade 20 such that the blade 20 may be reversed. The blades 20 may be set such that the cutting edge 31 of the blades 20 extends beneath the bottom surface 15 of the body 12 by a distance 17 that may vary depending upon soil conditions and desired removal rates. For example, in one illustrative embodiment, the distance 17 may range from approximately 3-6 inches.

The blades 20 may be made from a variety of materials, e.g., non-ferrous material, composites, non-metallic materials, etc. In general, the blades 20 may be made from a material having a hardness that is less than that of the materials commonly used for the piping of underground utilities, e.g., carbon steel, stainless steel, etc. Typical underground carbon steel piping for process or transfer lines may have a hardness that ranges from approximately 100-175 Brinell (for materials having an ultimate strength of approximately 55-75 ksi). In one illustrative embodiment, the blades 20 may be made of a material having a hardness less than that of steel, e.g., less than approximately 90 Brinell. For example, the blades 20 may be comprised of non-ferrous metallic materials, such as brass, copper, aluminum, etc. The blades 20 may also be comprised of a material such as nylon, bakelite, plastic, Teflon and rubber. In some cases, a hardness measurement standard other than the Brinell standard may be employed to measure the hardness of some of the blade materials, e.g., Teflon. Irrespective of the hardness measurement standard employed, the blade material should be selected such that it has a hardness less than that of the material of the underground piping. The thickness 19 (see FIG. 4A) of the blades 20 may vary depending upon the type of material used for the blades and the particular soil conditions. In one illustrative embodiment, the blades 20 may be comprised of nylon, and they have a thickness 19 of approximately one inch.

As shown in FIG. 4C, the deflectable member 29 is rotatably coupled to the top surface 13 of the body 12 by a plurality of hinges 13A. The deflectable member 29 extends some distance over the opening (14 or 16 as the case may be) formed in the body 12. The deflectable member 29 is depicted in its non-deflected position in FIG. 4C. The deflectable member 29 is adapted to deflect in the direction 41 when the tool 10 is digging into the soil to thereby allow soil to flow through the opening in the direction indicated by the arrow 43 and to accumulate above the top surface 13 of the tool 10. FIG. 4D shows the deflectable member 29 in its deflected position. After a certain amount of digging has been performed, a significant amount of soil will have accumulated above the top surface 13 of the body 12. At that time, the tool 10 will need to be withdrawn from the hole in the earth to remove the accumulated soil. As the tool 10 is being withdrawn, the deflectable member 29 returns to a position that approximates its original non-deflected position shown in FIG. 4C, thereby preventing the soil on the top surface 13 of the body 12 from falling back through the opening. The deflectable members 29 may be comprised of a variety of materials, and they may be coupled to the body 12 by a variety of techniques, such as mechanical hinges 13A.

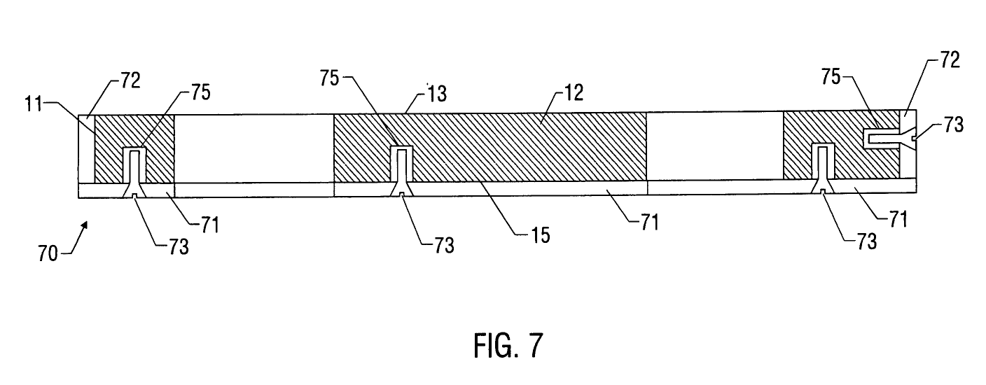

In another illustrative embodiment, depicted in FIG. 7, a protective layer 70 may be secured to at least the bottom surface 15 and edge 11 of the body 12. For example, in one embodiment, the protective layer 70 may be comprised of a relatively thin sheet of nylon, e.g., approximately 1/4″ thick, that is affixed to the body 12 by a plurality of nylon screws 73 that are threadingly engaged with threaded openings 75 formed in the body 12. This protective layer 70 may be comprised of a generally flat member 71 that is coupled to the bottom surface 15 of the body 12 and a ring-like member 72 that is coupled to the edge 11 of the body 12. The protective layer 70 may be comprised of any of the materials identified above for the blade 20.

In another illustrative embodiment, all of the components of the tool 10 may be made of a non-ferrous or non-metallic material such as those described above for the blades 20. For example, the body 12 and the blades 20 may be made of a material having a hardness less than approximately 90 Brinell, e.g., brass, copper, nylon, Teflon, rubber, plastic, bakelite, etc., and the blades 20 may be permanently affixed to the body 12. Alternatively, the body 12 may be made of brass, aluminum or copper, the blades 20 may be removably coupled to the body 12 and they may be comprised of copper, brass, nylon, plastic, rubber, Teflon or bakelite.

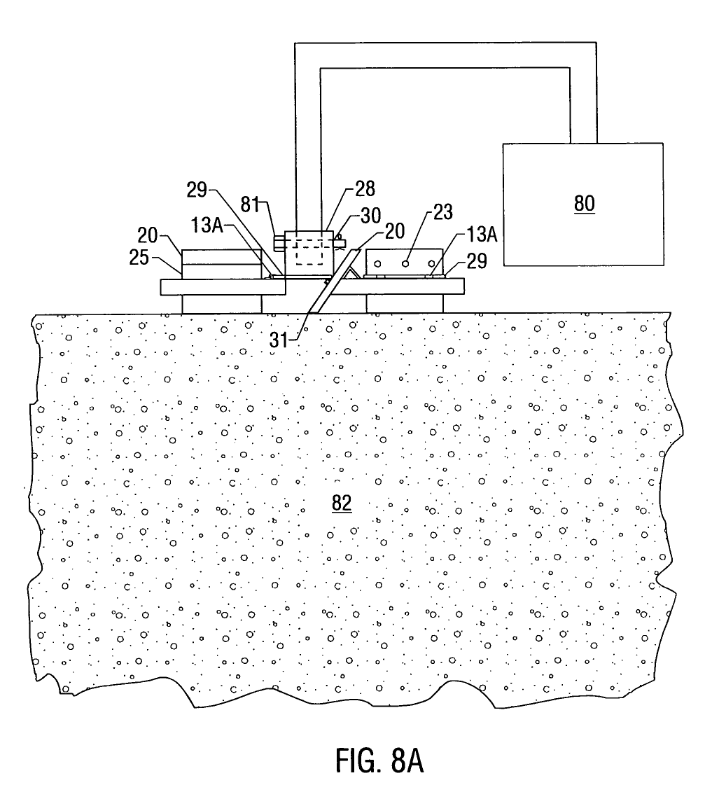

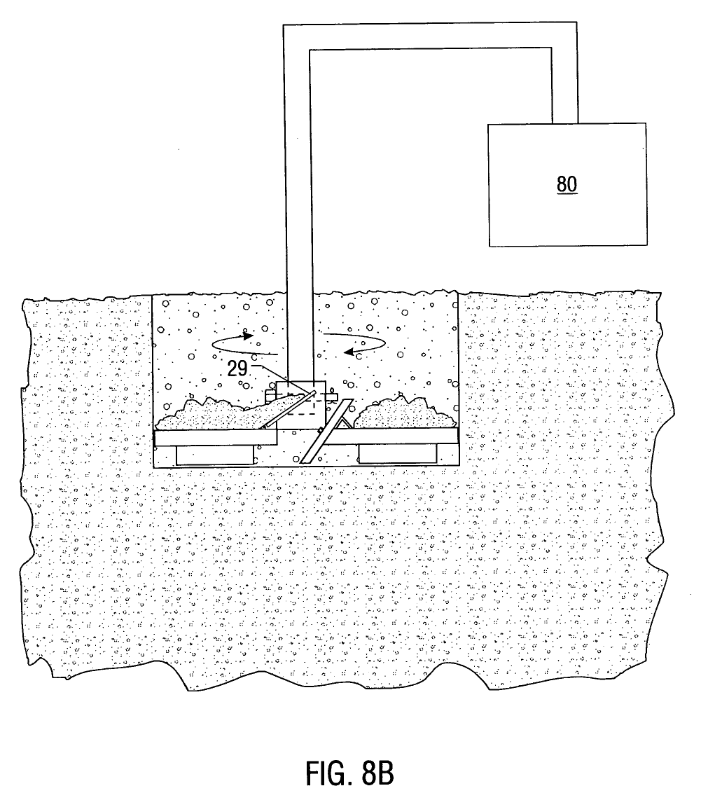

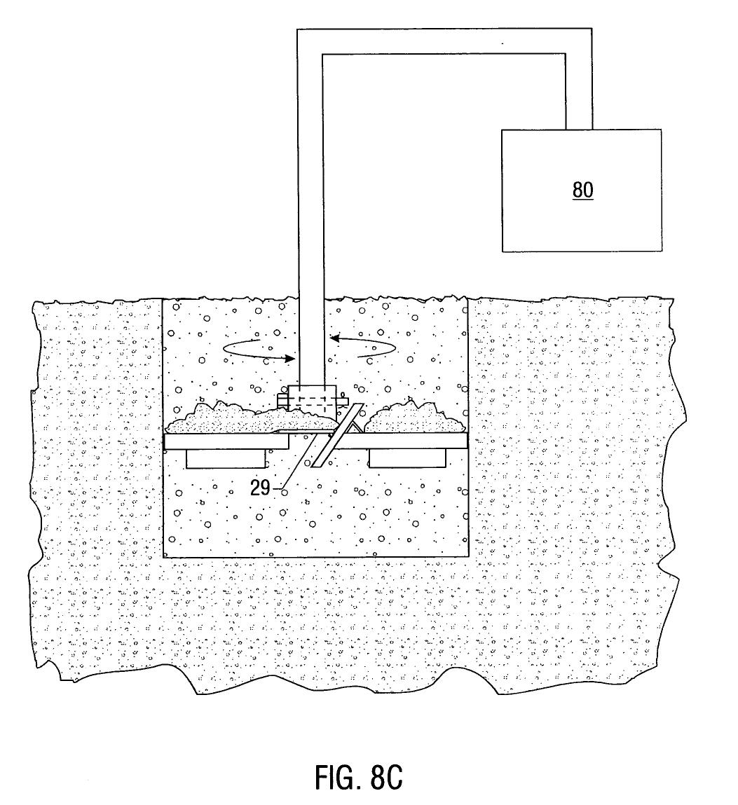

One illustrative example of the operation of the tool 10 will now be described with reference to FIGS. 8A-8C. In operation, where removable blades 20 are employed, the blades 20 are first coupled to the body 12 by the plurality of bolts 24. A drive member or rod of a drive tool, e.g., a digging machine 80, such as a pressure digger or boom digger, is operatively coupled to the kelley box 28 via use of a pin 81 that is positioned within the openings 30. Thereafter, as shown in FIG. 8A, the digging machine 80 provides rotary motion and downward force to the tool 10. As a result, the cutting edges 31 of the blades 20 begin to cut through the soil 82. As digging continues, the deflectable members 29 deflect to allow soil 82 to accumulate above the top surface 13 of the body 12. At some point, enough soil 82 has accumulated above the surface 13 of the body 12 that it needs to be removed. At that time, the tool 10 is pulled up out of the hole 84 and the soil 82 is removed from the top surface 13 of the tool 10. During this process, the vent tubes 26 are provided to insure that a vacuum does not develop between the body 12 and the surrounding soil 82. As the tool 10 is retracted, the deflectable members 29 move back into their initial non-deflected position depicted in FIG. 4C. In that position, the soil 82 removed by the digging apparatus 10 of the present invention is retained on the top 13 of the body 12 until such time as the tool 10 is removed from the hole 84 for purposes of removing the accumulated soil 82. This process is repeated until the hole 84 is at its desired depth.

Through use of the present invention, digging operations may be performed in areas having underground utilities, and they may be performed in a more safe and efficient manner. That is, the blades of the present invention are made from materials that will not cut into or penetrate underground metallic piping. As a result, less danger is encountered when digging operations are performed in areas where underground utilities are known or believed to be present.

The present invention is generally directed to various embodiments of a digging apparatus and to various methods of using such devices. In one illustrative embodiment, the apparatus comprises a body having a top surface and a bottom surface, a plurality of openings formed in the body and a blade positioned in each of the openings and coupled to the body, wherein a portion of the blade extends beyond the bottom surface of the body. In further embodiments, the blade is comprised of at least one of copper, brass, nylon, rubber, Teflon, plastic, bakelite or a material that has a hardness less than approximately 90 Brinell, i.e., a hardness less than that of the underground piping.

In another illustrative embodiment, the apparatus comprises a body, the body having a bottom surface, a plurality of generally rectangular openings formed in the body, and a removable nylon blade positioned in each of the openings and removably coupled to the body, a portion of the blade extending beyond the bottom surface of the body.

In a further illustrative embodiment, the apparatus comprises a body having a top surface and a bottom surface, a plurality of openings formed in the body, means for removing earthen material positioned in each of the openings and coupled to the body, a portion of the means for removing earthen material extending beyond the bottom surface of the body, and means for rotating the body. In one illustrative embodiment, the means for removing the earthen material is the blade 20. In another embodiment, the means for rotating the body is a digging machine, such as a pressure digger or a boom digger.

In yet another illustrative embodiment, a method of removing earthen material is disclosed which comprises providing a body having a top surface, a bottom surface and a plurality of openings formed in the body, positioning a blade in each of the openings and coupling the blade to the body, wherein a portion of the blade extends beyond the bottom surface of the body, positioning the blade in contact with an earthen surface, and rotating the body to advance the body into the earth. The method further comprises, after the body has been advanced by the rotation to thereby define a hole, removing the body from the hole and removing collected earthen material from above the top surface of the body. In some embodiments, the method further comprises repositioning the body in the hole after removing the collected earthen material and rotating the body to further increase a depth of the hole, wherein the body is rotated by applying a rotational force to a member that is coupled to a kelley box, the kelley box being fixedly coupled to the body.

The particular embodiments disclosed above are illustrative only, as the invention may be modified and practiced in different but equivalent manners apparent to those skilled in the art having the benefit of the teachings herein. For example, the process steps set forth above may be performed in a different order. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

1. A digging apparatus for use proximate an underground structure comprising a first material having a first hardness, comprising:
a body having a bottom surface;
a plurality of openings formed in said body; and
a plurality of blades formed of a second material having a second hardness less than the first hardness, the blade being positioned in each of said openings and coupled to said body, a portion of said blade extending beyond said bottom surface of said body.

2. The apparatus of claim 1, wherein said body has a generally cylindrical configuration.

3. The apparatus of claim 1, wherein said body has a circular cross-sectional configuration.

4. The apparatus of claim 1, wherein said body is comprised of a carbon steel or a stainless steel.

5. The apparatus of claim 1, wherein said body is comprised of a material having a hardness less than approximately 90 Brinell.

6. The apparatus of claim 1, wherein said body is comprised of at least one of copper, brass, nylon, rubber, Teflon, plastic and bakelite.

7. The apparatus of claim 1, wherein the second hardness is less than approximately 90 Brinell.

8. The apparatus of claim 1, wherein the second material is comprised of at least one of copper, brass, nylon, rubber, Teflon, plastic and bakelite.

9. The apparatus of claim 1, wherein said blade is removably coupled to said body.

10. The apparatus of claim 1, wherein said blade is fixedly coupled to said body.

11. The apparatus of claim 1, wherein said plurality of openings comprises four openings.

12. The apparatus of claim 1, wherein each of said openings has a generally rectangular configuration.

13. The apparatus of claim 9, wherein said blade is removably coupled to said body by a plurality of bolts.

14. The apparatus of claim 1, wherein said blade has a cutting edge formed on opposite ends of the blade.

15. The apparatus of claim 1, further comprising a kelley box coupled to said body, said kelley box adapted to receive a drive member therein.

16. The apparatus of claim 1, further comprising at least one vent outlet coupled to said body.

17. A digging apparatus, comprising:
a body having a bottom surface;
a plurality of openings formed in said body;
a blade positioned in each of said openings and coupled to said body, a portion of said blade extending beyond said bottom surface of said body; and
a deflectable member positioned over a portion of each of said openings, said deflectable member being hinged to said body.

18. A digging apparatus comprising:
a body having a bottom surface;
a plurality of openings formed in said body; and
a blade positioned in each of said openings and coupled to said body, a portion of said blade extending beyond said bottom surface of said body, wherein said blade is comprised of nylon.

19. The apparatus of claim 1, wherein said blade has a cutting edge formed on opposite ends of said blade and wherein said blade is reversible.

20. A digging apparatus, comprising:
a body having a bottom surface;
a plurality of openings formed in said body;
a blade positioned in each of said openings and coupled to said body, a portion of said blade extending beyond said bottom surface of said body; and
a protective cover layer positioned on a bottom surface of said body, said protective layer being comprised of a material having a hardness that is less than approximately 90 Brinell.

21. The apparatus of claim 20, wherein said protective cover layer is comprised of at least one of nylon, copper, brass, rubber, Teflon, plastic and bakelite.

22. A digging apparatus, comprising:
a body, said body having a bottom surface;
a plurality of openings formed in said body; and
a blade positioned in each of said openings, said blade being comprised of a material having a hardness less than approximately 90 Brinell, said blade being removably coupled to said body, a portion of said blade extending beyond said bottom surface of said body.

23. The apparatus of claim 22, wherein said body has a generally cylindrical configuration.

24. The apparatus of claim 22, wherein said body has a circular cross-sectional configuration.

25. The apparatus of claim 22, wherein said body is comprised of a carbon steel or a stainless steel.

26. The apparatus of claim 22, wherein said body is comprised of a material having a hardness less than approximately 90 Brinell.

27. The apparatus of claim 22, wherein said body is comprised of at least one of copper, brass, nylon, rubber, Teflon, plastic and bakelite.

28. The apparatus of claim 22, wherein said blade is comprised of at least one of copper, brass, nylon, rubber, Teflon, plastic and bakelite.

29. The apparatus of claim 22, wherein said plurality of openings comprises four openings.

30. The apparatus of claim 22, wherein each of said openings has a generally rectangular configuration.

31. The apparatus of claim 22, wherein said blade is removably coupled to said body by a plurality of bolts.

32. The apparatus of claim 22, wherein said blade has a cutting edge formed on opposite ends of the blade.

33. The apparatus of claim 22, further comprising a kelley box coupled to said body, said kelley box adapted to receive a drive member therein.

34. The apparatus of claim 22, further comprising at least one vent outlet coupled to said body.

35. The apparatus of claim 22, further comprising a deflectable member positioned over a portion of each of said openings.

36. The apparatus of claim 22, wherein said blade is comprised of nylon.

37. The apparatus of claim 22, wherein said blade has a cutting edge formed on opposite ends of said blade and wherein said blade is reversible.

38. The apparatus of claim 22, further comprising a protective cover layer positioned on a bottom surface of said body, said protective layer being comprised of a material having a hardness that is less than approximately 90 Brinell.

39. The apparatus of claim 38, wherein said protective cover layer is comprised of at least one of nylon, copper, brass, rubber, Teflon, plastic and bakelite.

40. A digging apparatus, comprising:
a body, said body having a bottom surface;
a plurality of openings formed in said body; and
a removable non-metallic blade positioned in each of said openings and removably coupled to said body, a portion of said blade extending beyond said bottom surface of said body.

41. The apparatus of claim 40, wherein said body has a generally cylindrical configuration.

42. The apparatus of claim 40, wherein said body has a circular cross-sectional configuration.

43. The apparatus of claim 40, wherein said body is comprised of a carbon steel or a stainless steel.

44. The apparatus of claim 40, wherein said body is comprised of a material having a hardness less than approximately 90 Brinell.

45. The apparatus of claim 40, wherein said body is comprised of at least one of copper, brass, nylon rubber, Teflon, plastic and bakelite.

46. The apparatus of claim 40, wherein said non-metallic blade is comprised of at least one of nylon, rubber, Teflon, plastic and bakelite.

47. The apparatus of claim 40, wherein said plurality of openings comprises four openings.

48. The apparatus of claim 40, wherein each of said openings has a generally rectangular configuration.

49. The apparatus of claim 40, wherein said removable non-metallic blade is removably coupled to said body by a plurality of bolts.

50. The apparatus of claim 40, wherein said non-metallic blade has a cutting edge formed on opposite ends of the blade.

51. The apparatus of claim 40, further comprising a kelley box coupled to said body, said kelley box adapted to receive a drive member therein.

52. The apparatus of claim 40, further comprising at least one vent outlet coupled to said body.

53. The apparatus of claim 40, further comprising a deflectable member positioned over a portion of each of said openings.

54. The apparatus of claim 40, wherein said non-metallic blade is comprised of nylon.

55. The apparatus of claim 40, wherein said non-metallic blade has a cutting edge formed on opposite ends of said blade and wherein said blade is reversible.

56. The apparatus of claim 40, further comprising a protective cover layer positioned on a bottom surface of said body, said protective layer being comprised of a material having a hardness that is less than approximately 90 Brinell.

57. The apparatus of claim 56, wherein said protective cover layer is comprised of at least one of nylon, copper, brass, rubber, Teflon, plastic and bakelite.

58. A digging apparatus, comprising:
a body, said body having a bottom surface;
a plurality of generally rectangular openings formed in said body; and
a removable nylon blade positioned in each of said openings and removably coupled to said body, a portion of said blade extending beyond said bottom surface of said body.

59. The apparatus of claim 58, wherein said body has a generally cylindrical configuration.

60. The apparatus of claim 58, wherein said body has a circular cross-sectional configuration.

61. The apparatus of claim 58, wherein said body is comprised of a carbon steel or a stainless steel.

62. The apparatus of claim 58, wherein said body is comprised of a material having a hardness less than approximately 90 Brinell.

63. The apparatus of claim 58, wherein said body is comprised of at least one of copper, brass, nylon, rubber, Teflon, plastic and bakelite.

64. The apparatus of claim 58, wherein said plurality of openings comprises four openings.

65. The apparatus of claim 58, wherein said removable nylon blade is removably coupled to said body by a plurality of bolts.

66. The apparatus of claim 58, wherein said nylon blade has a cutting edge formed on opposite ends of the blade.

67. The apparatus of claim 58, further comprising a kelley box coupled to said body, said Kelly box adapted to receive a drive member therein.

68. The apparatus of claim 58, further comprising at least one vent outlet coupled to said body.

69. The apparatus of claim 58, further comprising a deflectable member positioned over a portion of each of said openings.

70. The apparatus of claim 58, wherein said nylon blade has a thickness of approximately one inch.

71. The apparatus of claim 58, wherein said nylon blade has a cutting edge formed on opposite ends of said blade and wherein said blade is reversible.

72. A digging apparatus for use proximate an underground structure comprising a first material having a first hardness, comprising:
a body having a top surface and a bottom surface;
a plurality of openings formed in said body; and
means for removing earthen material comprising a second material having a second hardness less than the first hardness, said means being positioned in each of said openings and coupled to said body, a portion of said means for removing earthen material extending beyond said bottom surface of said body.

73. The apparatus of claim 72, wherein said means for removing earthen material is a blade.

74. The apparatus of claim 72, further comprising means for rotating said body.

75. The apparatus of claim 72, wherein said body has a generally cylindrical configuration.

76. The apparatus of claim 72, wherein said body is comprised of a carbon steel or a stainless steel.

77. The apparatus of claim 72, wherein said body is comprised of a material having a hardness less than approximately 90 Brinell.

78. The apparatus of claim 72, wherein said body is comprised of at least one of copper, brass, nylon, rubber, Teflon, plastic and bakelite.

79. The apparatus of claim 72, wherein the second material has a hardness less than approximately 90 Brinell.

80. The apparatus of claim 72, wherein the second material is comprised of at least one of copper, brass, nylon, rubber, Teflon, plastic and bakelite.

81. The apparatus of claim 73, wherein said blade is comprised of a material having a hardness less than approximately 90 Brinell.

82. The apparatus of claim 73, wherein said blade is comprised of at least one of copper, brass, nylon, rubber, Teflon, plastic and bakelite.

83. The apparatus of claim 72, wherein said means for removing earthen material is removably coupled to said body.

84. The apparatus of claim 72, wherein said means for removing earthen material is fixedly coupled to said body.

85. The apparatus of claim 72, wherein means for removing earthen material has a cutting edge formed on opposite ends of said means for removing earthen material.

86. The apparatus of claim 72, further comprising a kelley box coupled to said body, said kelley box adapted to receive a member therein.

87. The apparatus of claim 72, further comprising a deflectable means for covering at least a portion of one of said openings.

88. A digging apparatus, comprising:
a body having a top surface and a bottom surface;
a plurality of openings formed in said body;
means for removing earthen material positioned in each of said openings and coupled to said body a portion of said means for removing earthen material extending beyond said bottom surface of said body; and
a deflectable means for covering at least a portion of one of said openings, wherein said deflectable means is a plate that is hingedly coupled to said body.

89. A digging apparatus, comprising:
a body having a top surface and a bottom surface;
a plurality of openings formed in said body; and
means for removing earthen material positioned in each of said openings and coupled to said body, a portion of said means for removing earthen material extending beyond said bottom surface of said body wherein said means for removing earthen material is a blade comprised of nylon.

90. The apparatus of claim 72, wherein said means for removing earthen material is a blade that has a cutting edge formed on opposite ends of said blade and wherein said blade is reversible.

91. A digging apparatus, comprising:
a body having a top surface and a bottom surface;
a plurality of openings formed in said body;
means for removing earthen material positioned in each of said openings and coupled to said body, a portion of said means for removing earthen material extending beyond said bottom surface of said body; and
means for protecting said bottom surface of said body, said means for protecting said bottom surface being comprised of a material having a hardness that is less than approximately 90 Brinell.

92. The apparatus of claim 91, wherein said means for protecting said bottom surface is a protective cover layer that is comprised of at least one of nylon, copper, brass, rubber, Teflon, plastic and bakelite.

93. A method of removing earthen material proximate an underground structure comprising a first material having a first hardness, comprising:
providing a body having a top surface, a bottom surface and a plurality of openings formed in said body;
positioning a blade in each of said openings and coupling said blade to said body, each blade being formed of a second material having a second hardness less than the first hardness wherein a portion of each blade extends beyond said bottom surface of said body;
positioning said blades in contact with an earthen surface; and
rotating said body to advance said body into the earthen material.

94. The method of claim 93, further comprising after said body has been advanced by said rotation to thereby define a hole, removing said body from said hole and removing collected earthen material from above said top surface of said body.

95. The method of claim 94, further comprising repositioning said body in said hole after removing said collected earthen material and rotating said body to further increase a depth of said hole.

96. The method of claim 93, wherein said body is rotated by applying a rotational force to a member that is coupled to a kelley box, said kelley box being fixedly coupled to said body.

97. The method of claim 93, wherein said body has a generally cylindrical configuration.

98. The method of claim 93, wherein said body is comprised of a carbon steel or a stainless steel.

99. The method of claim 93, wherein said body is comprised of a material having a hardness less than approximately 90 Brinell.

100. The method of claim 93, wherein said body is comprised of at least one of copper, brass, nylon, rubber, Teflon, plastic and bakelite.

101. The method of claim 93, wherein the second hardness is less than approximately 90 Brinell.

102. The method of claim 93, wherein the second material is comprised of at least one of copper, brass, nylon, rubber, Teflon, plastic and bakelite.

103. The method of claim 93, wherein said blade is removably coupled to said body.

104. The method of claim 93, wherein said blade is fixedly coupled to said body.

105. The method of claim 93, wherein said plurality of openings comprises four openings.

106. The method of claim 93, wherein each of said openings has a generally rectangular configuration.

107. The method of claim 93, wherein said blade has a cutting edge formed on opposite ends of the blade.

108. A method of removing earthen material comprising:
providing a body having a top surface, a bottom surface and a plurality of openings formed in said body;
positioning a blade in each of said openings and coupling said blade to said body wherein a portion of said blade extends beyond said bottom surface of said body;
positioning said blades in contact with an earthen surface;
rotating said body to advance said body into the earthen material; and
positioning a deflectable member over a portion of each of said openings, said deflectable member being hinged to said body.

109. A method of removing earthen material, comprising:
providing a body having a top surface, a bottom surface and a plurality of openings formed in said body;
positioning a blade in each of said openings and coupling said blade to said body, wherein a portion of said blade extends beyond said bottom surface of said body wherein said blade is comprised of nylon;
positioning said blades in contact with an earthen surface; and rotating said body to advance said body into the earthen material.

110. The method of claim 93, wherein said blade has a cutting edge formed on opposite ends of said blade and wherein said blade is reversible.

111. A method of removing earthen material, comprising:
providing a body having a top surface, a bottom surface and a plurality of openings formed in said body;
positioning a blade in each of said openings and coupling said blade to said body wherein a portion of said blade extends beyond said bottom surface of said body,
positioning a protective cover layer on said bottom surface of said body, said protective layer being comprised of a material having a hardness that is less than approximately 90 Brinell;
positioning said blades in contact with an earthen surface; and
rotating said body to advance said body into the earthen material.

112. The method of claim 111, wherein said protective cover layer is comprised of at least one of nylon, copper, brass, rubber, Teflon, plastic and bakelite.

113. (Canceled)
